(19) United States
(12) Patent Application Publication
(10) Pub. No.: US 2021/0069980 A1
(43) Pub. Date: Mar. 11, 2021

(54) Additively Manufactured Plastic Scintillation Detector

(71) Applicant: The Government of the United States of America, as represented by the Secretary of the Navy, Arlington, VA (US)

(72) Inventors: Bradford Baker, Edgewater, MD (US); Peter Joyce, Annapolis, MD (US); Marshall Millett, Annapolis, MD (US)

(21) Appl. No.: 16/567,802

(22) Filed: Sep. 11, 2019

(51) Int. Cl. B29C 64/314; G01T 1/203; B33Y 40/10; B33Y 70/00; B33Y 80/00

(52) U.S. Cl. CPC B29C 64/314; G01T 1/2033; B33Y 10/00; B33Y 70/00; B33Y 80/00; B33Y 40/10

(57) ABSTRACT

A method of manufacturing a radiation detector includes adding a fluorescing medium to an additive manufacturing consumable to form a consumable mixture; additively manufacturing a plastic scintillator from the consumable mixture; and coupling the plastic scintillator to a light-to-current device, thereby forming an additively manufactured plastic scintillation detector.

### FEDERALLY-SPONSORED RESEARCH AND DEVELOPMENT

The United States Government has ownership rights in this invention.

### FIELD OF INVENTION

The present invention relates generally to radiation detectors, and more particularly to additively manufactured scintillation detectors.

### BACKGROUND

Radiation detectors are often used to prevent the movement of illicit radioactive materials. A commonly used radiation detector is a scintillator. Several examples of organizations that utilize scintillators include cargo shipment inspectors, postal workers, and the Transportation Security Administration (TSA). Radiation detectors are essential to the defense of this nation against weapons of mass destruction (WMD).

There are a variety of scintillation detectors commonly used for radiation detection and monitoring. These include organic, inorganic, and gaseous scintillators. Material density plays a large role in scintillation detectors, and while plastic scintillators are intrinsically less efficient than inorganic scintillators they are comparatively less expensive, have less total mass for the same size, and offer greater flexibility in manufacturing than inorganic crystal or other common scintillators.

Plastic scintillators are traditionally either found naturally occurring or more commonly synthetically made through a polymerization process. Once formed these scintillators are made into stock shapes via extrusion other standard plastic manufacturing processes such as molding. Traditional plastic scintillators use a fluorescent material which acts as the primary scintillating medium suspended in a polymer matrix. This mixture of fluorescent medium and base is then often poured into a mold for final forming or extruded through a die similar to traditional plastic manufacturing.

### SUMMARY OF INVENTION

These traditional plastic forming processes require complex molding and forming methods which add significantly to total cost, often require post processing, and limit manufacturing capability. Exemplary embodiments of the invention add a fluorescent medium to any standard additive manufacturing consumable, producing a net shape that is formed using a modified standard additive manufacturing process. The produced net shape can be made such that it requires little to no post processing, can be adopted to a variety of light measuring or storing systems, and does not require any additional mold, casting, or other forming process.

According to one embodiment of the invention, a method of manufacturing a radiation detector includes adding a fluorescing medium to an additive manufacturing consumable to form a consumable mixture; additively manufacturing a plastic scintillator from the consumable mixture; and coupling the plastic scintillator to a light-to-current device, thereby forming an additively manufactured plastic scintillation detector.

Optionally, the fluorescing medium is anthracene.

Optionally, the consumable mixture is 1% or less of anthracene.

Optionally, the consumable mixture is 0.1-0.3% anthracene.

Optionally, the consumable mixture is about 0.3% anthracene.

Optionally, the light-to-current device is a photo multiplier tube.

Optionally, the additively manufacturing step is Fused Deposition Modeling.

Optionally, the additively manufacturing step is Fixed Filament Fabrication.

Optionally, the additively manufacturing step is Powder Bed Fusion.

Optionally, the additively manufacturing step is stereolithography.

The foregoing and other features of the invention are hereinafter described in greater detail with reference to the accompanying drawings.

### BRIEF DESCRIPTION OF THE DRAWINGS

FIG. 1 shows a simplified view of radiation detection with a scintillator detector;

FIG. 2 shows a schematic diagram of an exemplary scintillator detector;

FIG. 3 shows a block diagram of an exemplary method for making a scintillator detector.

### DETAILED DESCRIPTION

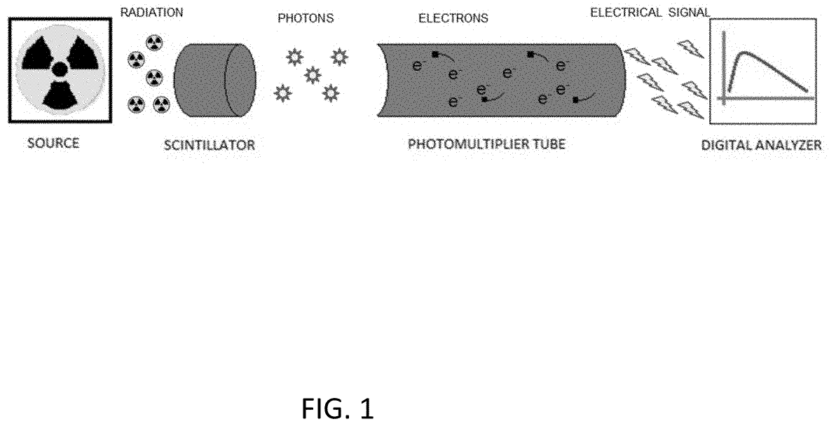

The fundamental objective of exemplary embodiments of the invention is to convert ionizing radiation from a radiation source to a measurable signal such that the source can be discriminated from background radiation. This is achieved by placing the detector in proximity to the radiation source; creating a scintillating medium which converts the incident ionizing radiation flux to visible light; converting the light to a useful signal; and analyzing the resultant signal to discriminate the source from background. A simplified diagram of this process is depicted in FIG. 1.

Exemplary methods create a solid plastic scintillating medium via additive manufacturing that produces a light output from an incident ionizing radiation source. When coupled with a light-to-converted or -stored-energy mechanism such as a photo multiplier tube, photo diode, or other light sensing source, exemplary additively manufactured plastic scintillation detectors are created.

An objective of these exemplary embodiments is to convert ionizing radiation from a radiation source to a measurable signal such that the source can be discriminated from background radiation. This is achieved by placing the detector in proximity to the radiation source; creating a scintillating medium which converts the incident ionizing radiation flux to visible light; converting the light to a useful signal; and analyzing the resultant signal to discriminate the source from background. A cartoon diagram of this process is depicted in FIG. 1.

An exemplary additive manufactured plastic scintillation detector is made by first adding a fluorescing medium to a standard additive manufacturing consumable. As a non-limiting example, anthracene, a solid aromatic hydrocarbon in powder form, may be added to a commercially available ultra violet light curable resin. Specific control of temperature, mechanical agitation, and appropriate concentrations are necessary to make this step successful, and the exact procedure will vary based on the material combination. After reading and understanding this disclosure, one having ordinary skill in the art should be able to apply this method without undue experimentation. Those skilled in the art will need to control the temperature, agitation, and use appropriate concentration so as to enable the scintillating material to be dissolved, and then to stay in solution during the stereolithography (SLA) process. Preferably, 1% or less anthracene is used. More preferably, 0.1-0.3% anthracene is used. Most preferably, about 0.3% anthracene is used.

Although the above illustrative steps are given with respect to an SLA process, it should be noted that other exemplary embodiments could use other additive manufacturing techniques, and non-exhaustive examples are discussed below.

Referring once more to the example SLA process, the resulting mixture of fluorescent medium and additive manufacturing consumable is then used as a modified consumable for use in a standard additive manufacturing process. In a non-limiting example, scintillator doped resin may be used in a commercially available stereolithography (SLA) process with modification producing a final part that is in its entirety an additively manufactured plastic scintillator.

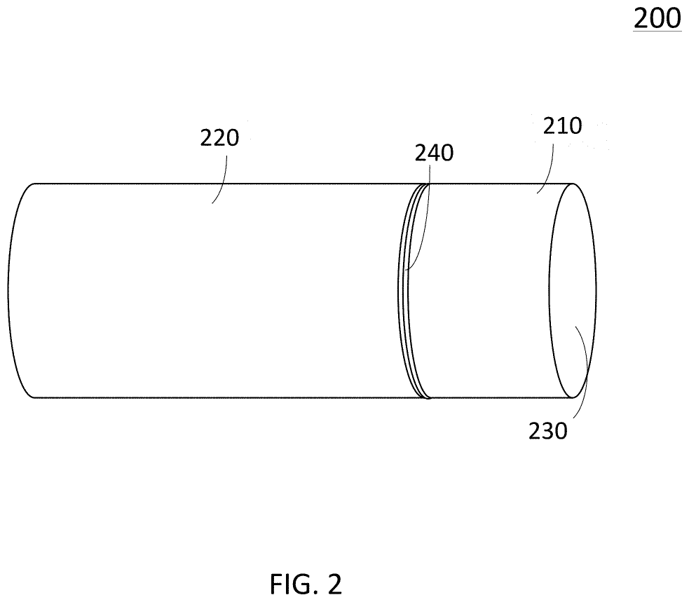

By itself, the additively manufactured plastic scintillator will produce light from an ionizing radiation source, but when coupled with a light-to-current device such as a photomultiplier tube or other energy storage system, the composite device becomes and additively manufactured plastic scintillation detector 200, as shown in schematic form in FIG. 2. In a non-limiting example, a standard stock shape such as a cylinder 210 may be combined with a commercially available photomultiplier tube 220. As is known in the art, the scintillator 210 may have a reflector 230 (e.g. reflective paint layer) coupled to one end in order to direct produced light towards the photomultiplier tube. Also, a layer of medium 240 such as silicone grease may be placed between the scintillator 210 and the photomultiplier tube 220 to increase optical coupling.

Exemplary embodiments have distinct advantages over traditionally-manufactured plastic scintillation detectors. Specifically, the additively-manufactured scintillation detector can be made such that is requires little to no post processing, the scintillating medium can easily be adopted to any geometry for light to signal processing, and the detector requires no mold, casting, or other manufacturing process. The additively manufactured detector also has intrinsic advantages associated with additive manufacturing which include the ability to print complex geometries or designs not possible with traditional manufacturing, a potentially expedited manufacturing process since custom molds or castings are not required, and overall a more rapid design to product manufacturing capability.

Exemplary detectors also have a significant advantage in that the exemplary scintillator is made from a multifunctional material; specifically, the detector has the ability to serve as a radiation detection device while also serving as a structural component either on its own directly or as part of a composite unit. Two potential applications of this feature will be discussed to highlight this advantage.

There is a well-established need for unmanned material reconnaissance to monitor for radiation sources. In most of these attempts, a radiation detector that is often heavy and obtrusive is mounted to an unmanned aerial vehicle (UAV). With exemplary embodiments of the invention, portions of the UAV could be made from the exemplary additive process allowing both a customizable geometry, low total mass, and adequate structural integrity while also serving as the radiation detector.

Similarly, for personnel monitoring, exemplary embodiments of the invention could be incorporated into existing personnel protective equipment (PPE) such as helmets, vests, backpacks, or other worn device offering the same advantages mentioned for UAVs. Wearable dosimeters could include a standard belt, clip, lanyard, or other common dosimeter. Applications where the dosimeter is integral to clothing, equipment, or other worn component could include incorporating a scintillator into plastic linings, covering, or inserts that could be integrated into protective equipment such as helmets, vests, or aprons in order to accomplish both personnel protection as well as radiation monitoring. Extremity monitoring systems including ring dosimeters or integration of the dosimeter in personnel protective devices such as gloves, booties, or other worn devices is also possible. Finally, discrete, unobtrusive dosimeters can be made to mimic common devices such as lapel pins, nametags, belt buckles, or other common devices.

Additionally, exemplary embodiments may be incorporated into conventional radiation screening devices, such as, for example: large scale screening devices such as portal monitoring devices at airports, ports of entry, or other large screening locations; and small scale screening devices such as baggage screening systems or handheld screening devices for personnel or equipment.

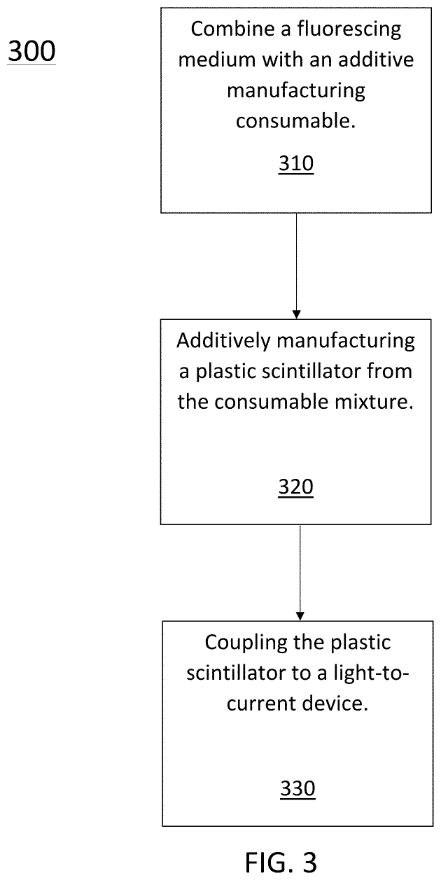

Referring now to FIG. 3, an exemplary additive manufactured plastic scintillation detector is made by process 300. First, at block 310, a fluorescing medium is added to a standard additive manufacturing consumable. For example, in a preferred embodiment, anthracene, a solid aromatic hydrocarbon in powder form, is added to a commercially available ultra violet light curable resin. Varying concentrations of anthracene have been evaluated and solubility of scintillator and additive manufacturing consumable have been considered. However, this step of mixing is not limited to these specific materials, and exemplary processes may include any plastic filament and any suitable fluorescing medium.

At block 320, the resulting mixture of fluorescent medium and additive manufacturing consumable is then used as a modified consumable in a conventional additive manufacturing process. For example, a preferred embodiment includes a scintillator doped resin being used in a commercially available stereolithography (SLA) process with modification producing a final part that is—in its entirety—an additively manufactured plastic scintillator.

By itself the additively manufactured plastic scintillator will produce light from an ionizing radiation source. However, as shown at block 330, when coupled with a light-to-current device such as, for example, a photo multiplier tube (PMT) or other energy storage system, the composite device becomes an additively manufactured plastic scintillation detector. In a preferred embodiment, for example, a conventional stock shape was combined with a commercially available photo multiplier tube.

PMTs have a photosensitive surface, known as a photocathode, which absorbs photons and emits electrons. These electrons then travel to a focusing electrode. The focusing electrode is responsible for ensuring the electrons hit the first dynode. Dynodes often serve as electron multipliers in the PMT. As the number of dynodes increases, the PMT gain also increases. At the end of the PMT there is an anode which collects the amplified electrons. The collected electrons create a current which is directly proportional to the photoelectron flux generated by the photocathode.

As mentioned above, alternative additive manufacturing techniques are contemplated by this invention. For example, a scintillating material can be added to a plastic filament and then used in a Fused Deposition Modeling (FDM) or Fixed Filament Fabrication (FFF) process to produce a comparable additively manufactured plastic scintillation detector. Similarly, a scintillating material in powder form could be added to a Powder Bed Fusion (PBF) additive manufacturing process. In each of these cases the stability of the scintillating medium in the additive manufacturing consumable and during the additive manufacturing process must be evaluated.

With regard to an FDM process, for example, a solid form scintillating material may be mixed with a solid plastic form additive manufacturing consumable to make a FDM filament that could be used in almost any FDM printer. Commercial solutions already exist for users to make their own filament from recycled plastics, and such a system could be utilized to add the scintillating material. Lower temperature FDM processes are preferable for preserving the scintillating properties in FDM printing. Therefore, a preferred consumable would be, for example, polylactic acid (PLA).

With regard to a PBF process, for example, a powdered scintillating material may be mixed with the powdered consumable. There are electrostatic techniques available to increase miscibility of powders that can readily be applied to this mixing to enable thorough mixing. Again, lower temperature processes are preferred, and, therefore, non-metal PBF processes would be a preferable material selection. In particular, a preferred embodiment uses a powdered scintillating material mixed with nylon powder (potentially with additional processes such as electrostatic charging) in a selective laser sintering (SLS) process to produce a final non-metal scintillating part.

Finally, the end product must be able to perform as intended, capable of accomplishing the following effects: (1) absorb incident ionizing radiation, (2) convert that radiation flux to light, and (3) allow that light to be detected by another portion of the detector. First, the bulk portion of the part (i.e. the raw additive manufacturing consumable) should have negligible interaction with the incident ionizing radiation flux: specifically no absorption and minimal scattering. Second, the raw additive manufacturing consumable should not interfere with the scintillation of the scintillating material. Lastly, the final part—which is largely constituted from the raw additive manufacturing consumable—needs to be reasonably transparent to the specific wavelength of the scintillating material (this is one of the primary advantages of anthracene) such that the radiation-to-converted-light signal can be transferred to the electronic portion of a final dosimeter.

In SLA the bulk additive manufacturing consumable has negligible interaction with ionizing radiation (due primarily to its low density) and reasonably transparent additive manufacturing consumables are readily available. Combining the same scintillating material to a transparent PLA should have similar success. Achieving this final step in a PBF process with a powder scintillating material and powder based additive manufacturing consumable may be more challenging than SLA or FDM approaches, but there are approaches that can be used. Density and transparency of the additive manufacturing consumable are key factors, and for this reason a non-metal powder such as nylon is preferred. Additionally, lower final thickness of a denser or less transparent medium may be required to produce the desired effect, in some cases.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of manufacturing a radiation detector comprising the steps of:
adding a fluorescing medium to an additive manufacturing consumable to form a consumable mixture;
additively manufacturing a plastic scintillator from the consumable mixture;
coupling the plastic scintillator to a light-to-current device, thereby forming an additively manufactured plastic scintillation detector.

2. The method of claim 1, wherein the fluorescing medium is anthracene.

3. The method of claim 2, wherein the consumable mixture is 1% or less of anthracene.

4. The method of claim 3, wherein the consumable mixture is 0.1-0.3% anthracene.

5. The method of claim 3, wherein the consumable mixture is about 0.3% anthracene.

6. The method of claim 1, wherein the light-to-current device is a photo multiplier tube.

7. The method of claim 1, wherein the additively manufacturing step is Fused Deposition Modeling.

8. The method of claim 1, wherein the additively manufacturing step is Fixed Filament Fabrication.

9. The method of claim 1, wherein the additively manufacturing step is Powder Bed Fusion.

10. The method of claim 1, wherein the additively manufacturing step is stereolithography.
